(19) United States
(12) Patent Application Publication
(10) Pub. No.: US 2010/0118175 A1
(43) Pub. Date: May 13, 2010

(54) Imaging Apparatus For Image Integration

(76) Inventor: Victor Charles Bruce, Tarpon Springs, FL (US)

Correspondence Address: Ashok Tankha, 36 Greenleigh Drive, Sewell, NJ, 08080, US

(21) Appl. No.: 12/605,315

(22) Filed: Oct. 23, 2009

Related U.S. Application Data
(60) Provisional application No. 61/113,222, filed on Nov. 10, 2008.

(51) Int. Cl. H04N 9/76; H04N 5/222

(52) U.S. Cl. 348/333.05; 348/598; 348/E09.057; 348/E05.022

(57) ABSTRACT

A method and imaging apparatus is provided for integrating a first image into a second image. An image capture device comprising at least one first lens and at least one second lens is provided. An image integration software application is provided which utilizes an interface on the image capture device. The image integration software application supports the first lens and the second lens for providing the first image and the second image from different directions. The operator previews the second image using the image capture device, and selects a location in the previewed second image on the interface for the integration. The operator captures the previewed second image and the first image using the second lens and the first lens respectively. The image integration software application integrates the captured first image and the captured second image at the selected location to facilitate combination of image effects in a composite image.

### CROSS REFERENCE TO RELATED APPLICATIONS

This application claims the benefit of provisional patent application No. 61/113,222 titled “Imaging Apparatus For Image Integration”, filed on Nov. 10, 2008 in the United States Patent and Trademark Office.

The specification of the above referenced patent application is herein incorporated by reference in its entirety.

### BACKGROUND

This disclosure, in general, relates to image capturing and processing, and more particularly, relates to integrating a first image of an operator into a second image that does not include an image of the operator, whereby desired image combinations and effects may be achieved.

Cameras and other imaging devices are typically used by an operator to capture images. Conventional cameras comprise a photographic lens mounted on the front of the camera, a viewfinder, a preview screen, and various camera controls located on the rear and around the periphery of the camera. The operator may use the viewfinder, the preview screen, and the camera controls to capture an image of a focused area distal of the front side of the camera. This image is captured, of course, exclusive of any image of the operator who is behind the camera. If, for example, an image of a group of people is to be captured by an operator using a camera, that operator must operate the camera and therefore will not appear in the image. A person from outside the group of people would normally be required to capture an image which includes all the people. The person requested to capture the image may be a stranger and this may not always be desirable and may create an uncomfortable situation.

A self timer feature of the camera may be used to capture an image inclusive of all the people. However, the self timer feature requires precise camera and subject positioning and physical abandonment of the camera by the operator, making the camera susceptible to shake, instability, falling, improper centering of an image, theft, etc. Furthermore, the operator needs to set a countdown for the self timer and return to a desired position in the focused area before the countdown period expires. Under these circumstances, the operator is unable to preview the image immediately prior to the capturing of the image.

Hence, there has been a long existing need in the art for an imaging apparatus that integrates a first image of an operator into a second image that does not include the image of the operator and overcomes the aforementioned difficulties and deficiencies.

### SUMMARY

This summary is provided to introduce a selection of concepts in a simplified form that are further described in the detailed description of the invention. This summary is not necessarily intended to identify key or essential inventive concepts of the claimed subject matter, nor is it intended for determining the scope of the claimed subject matter.

The method and imaging apparatus disclosed herein addresses the above stated need for integrating a first image into a second image. An image capture device comprising at least one first lens and at least one second lens is provided to an operator. The first lens is positioned in a rearward facing location on the image capture device which focuses in directions, for example, the rear direction, so as to capture an image of an operator or the like. The second lens is positioned in a forward facing location on the image capture device which focuses in directions, for example, the forward direction so as to capture a second image. An image integration software application is provided on the image capture device. The image integration software application utilizes an interface on the image capture device. The operator previews the second image using the image capture device. The operator selects a location in the previewed second image on the interface for the integration. The operator selects the location in the previewed second image using, for example, a touch screen or multiple selection control buttons provided on the image capture device. The operator selects the previewed second image using the selection control buttons. The image integration software application activates the first lens and the second lens for enabling the capture of the first image and the capture of the previewed second image respectively.

The operator captures the previewed second image using the second lens of the image capture device. The operator simultaneously captures the first image using the first lens of the image capture device. The image capture device may comprise a first flash unit and a second flash unit synchronized and coordinated via suitable monitoring and control software, including, for example, light sensors, for providing illumination during the capture of the first image and the previewed second image, respectively. A flash control unit is provided on the image capture device for selectively controlling the illumination level and timing of the first flash unit and the second flash unit during the capture of the first image and the previewed second image. Light sensors may be provided on the image capture device for sensing the amount of light incident on the first lens and the second lens during the capture of the first image and the previewed second image.

The image integration software application integrates the captured first image and the captured second image at the selected location to create a composite image. For example, either the captured first image is superimposed over the captured second image or the captured second image is superimposed over the captured first image to create the composite image. The captured first image, for example, includes the operator and the captured second image does not include the operator. Therefore, the first image of the operator is integrated into the second image that does not include the operator using the image capture device. The created composite image therefore includes the image of the operator in the second image. Multiple capture control buttons are provided on the image capture device for providing flexible options to the operator during the capture of the first image and the previewed second image. The image integration software application processes the captured first image, the captured second image, and the composite image based on preferences of the operator. The operator sets the preferences on the image capture device using one or more of the selection control buttons. The created composite image is displayed on the interface on the image capture device.

In an embodiment of the method and imaging apparatus disclosed herein, the operator has an option of inserting a third image, for example, an image of the operator, as a signature in a forward captured image using one of the selection control buttons. After one of the selection control buttons is pressed, the image integration software application inserts the operator's image into the forward captured image as the signature at a predefined location on the captured image or at a location selected by the operator.

### BRIEF DESCRIPTION OF THE DRAWINGS

The foregoing summary, as well as the following detailed description, is better understood when read in conjunction with the appended drawings. For the purpose of illustrating the various embodiments, exemplary constructions are shown in the drawings. However, the invention is not limited to the specific methods and instrumentalities disclosed herein.

FIG. 1 illustrates a method of integrating a first image into a second image.

FIG. 2 exemplarily illustrates a block diagram of an imaging apparatus that integrates a first image into a second image.

FIG. 3 exemplarily illustrates a rear view of an imaging apparatus with a standard display and control buttons.

FIG. 4 exemplarily illustrates a rear view of the imaging apparatus with a touch screen and control buttons.

FIG. 5 exemplarily illustrates a flowchart comprising the steps of capturing an image of an operator using a rear lens on the image capture device.

FIG. 6 exemplarily illustrates a flowchart comprising the steps of integrating a first image of an operator into a second image of photograph subjects.

FIG. 7 exemplarily illustrates a flowchart comprising the steps of inserting a thumbnail sized first image into a second image, as a signature.

### DETAILED DESCRIPTION

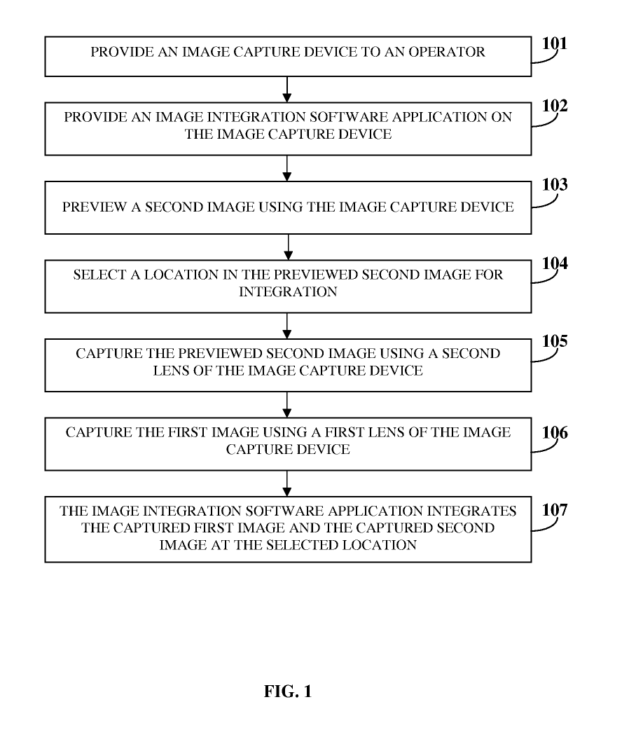

Referring now to the drawings wherein like reference numerals denote like or corresponding parts, elements, components or steps, throughout the drawings. FIG. 1 illustrates a method of integrating a first image into a second image. An image capture device comprising a first optical unit and a second optical unit is provided 101 to an operator. The first optical unit and the second optical unit refer to lenses and other optical elements that enable the generation of images. Herein, the first optical unit is exemplarily referred to as a “first lens” and the second optical unit is exemplarily referred to as a “second lens”. For purposes of illustration, the detailed description refers to a first lens and a second lens; however the scope of the method and imaging apparatus disclosed herein is not limited to a single first lens and a single second lens but may be extended to include multiple first lenses and second lenses provided on the image capture device that are used to capture images from different directions. The first lens is positioned in a rearward facing location on the image capture device which focuses in directions, for example, the rear direction, so as to capture an image of an operator or the like. The second lens is positioned in a forward facing location on the image capture device which focuses in directions, for example, the forward direction so as to capture a second image.

An image integration software application is provided 102 on the image capture device. The image integration software application may comprise any suitable programming language that can be compiled for execution on the image capture device. The image integration software application may be implemented using, for example, a C programming language, a C++ programming language, Java™ Micro Edition, and other programming languages known to one of ordinary skill in the art for image systems by camera designers familiar with camera and imaging controls, touch screen technology and the like. The image integration software application utilizes an interface on the image capture device. The operator previews 103 the second image using the image capture device. The second image is, for example, an image of multiple subjects excluding the operator. For example, the second image may be an image of friends of the operator at a park.

The operator selects 104 a location in the previewed second image on the interface for the integration. The operator selects the location in the previewed second image using a touch screen or multiple selection control buttons provided on the image capture device. The operator may also select the previewed second image using the selection control buttons. The image integration software application activates the first lens and the second lens for enabling the capture of the first image and the capture of the previewed second image respectively. The operator captures 105 the previewed second image using the second lens of the image capture device. The operator then captures 106 the first image using the first lens of the image capture device. The first image is, for example, an image of the operator. The image integration software application integrates 107 the captured first image and the captured second image at the selected location to create a composite image. The integration comprises superimposing the captured first image over the captured second image or the captured second image over the captured first image. The captured first image, for example, includes the operator and the captured second image, for example, does not include the operator. Therefore, the first image of the operator is integrated into the second image that does not include the operator using the image capture device. The created composite image therefore includes the image of the operator in the second image. The created composite image is displayed on the interface on the image capture device.

The image integration software application processes the captured first image, the captured second image, and the composite image based on preferences of the operator. The operator sets the preferences using one or more of the selection control buttons.

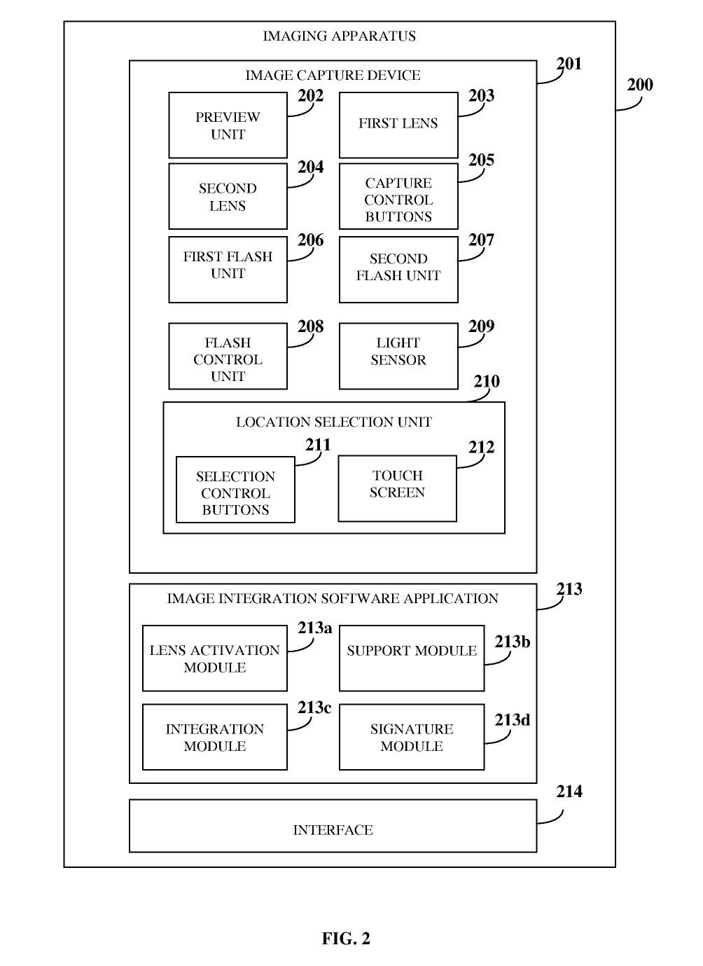

FIG. 2 exemplarily illustrates a block diagram of an imaging apparatus 200 that integrates a first image into a second image. The imaging apparatus 200 comprises an image capture device 201, an image integration software application 213, and an interface 214 controlled by the image integration software application 213. The image capture device 201 is, for example, a digital camera, a digital video camera, a mobile phone, medical imaging devices, or any other suitable imaging device. The image capture device 201 comprises a preview unit 202, a location selection unit 210, a first lens 203, a second lens 204, a first flash unit 206, a second flash unit 207, multiple capture control buttons 205, a flash control unit 208, and one or more light sensors 209. The image integration software application 213 comprises a lens activation module 213a, a support module 213b, an integration module 213c, and a signature module 213d.

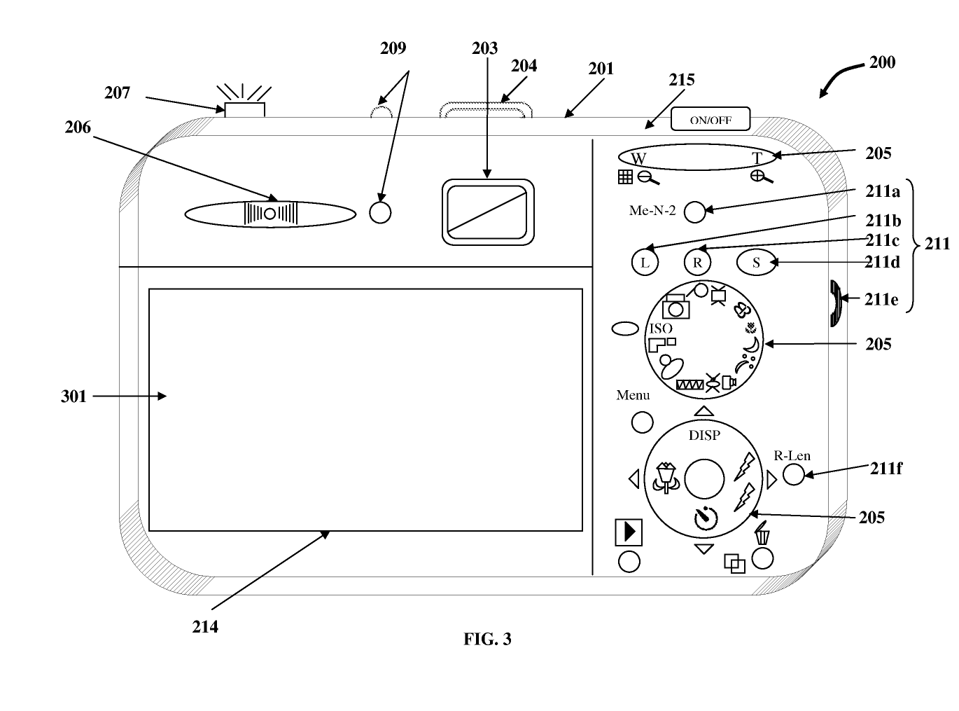

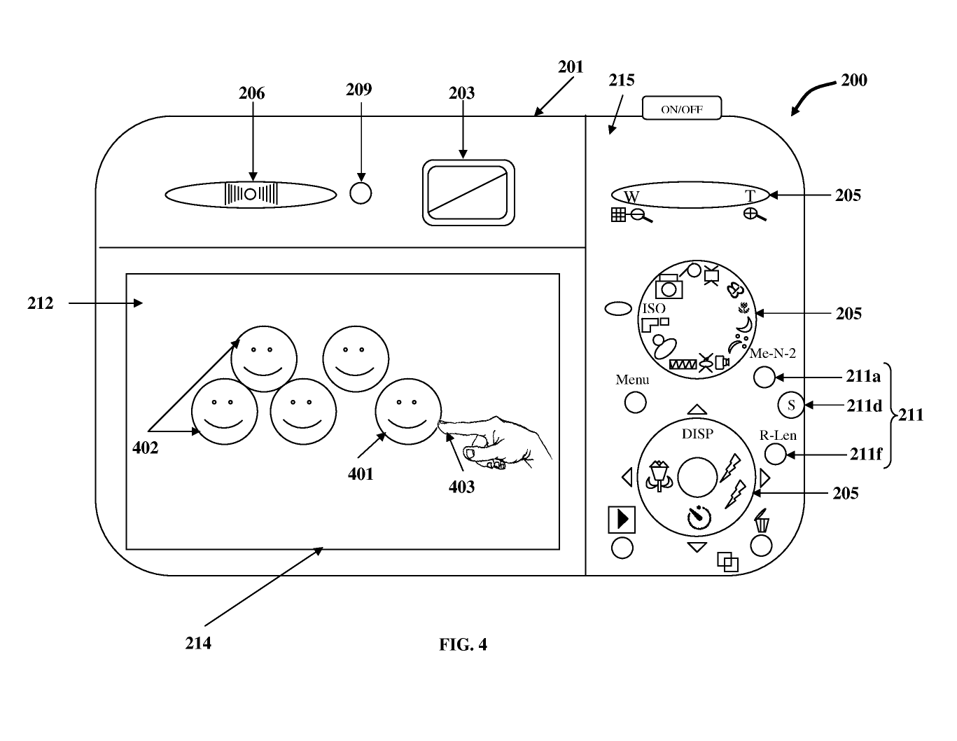

The preview unit 202 of the image capture device 201 enables the operator to preview the second image. The preview unit 202 also comprises a display screen, for example, a liquid crystal display, for previewing the second image. The display screen is, for example, a touch screen 212 as exemplarily illustrated in FIG. 2 and FIG. 4 or a standard display 301 as exemplarily illustrated in FIG. 3. The location selection unit 210 enables the operator to select a location 401 in the previewed second image for the integration. The location selection unit 210 comprises multiple selection control buttons 211. The location selection unit 210 enables the operator to select the location 401 in the previewed second image using the touch screen 212 or the selection control buttons 211. The operator sets preferences on the image capture device 201 using one or more of the selection control buttons 211 and the capture control buttons 205. The interface 214 under control of the image integration software application 213 accepts the location 401 selected by the operator. The operator selects the location 401 using a combination of the interface 214 and the location selection unit 210. The first lens 203 is positioned in a rearward facing location on the image capture device 201 and the second lens 204 is positioned in a forward facing location on the image capture device 201. The first lens 203 captures the first image and the second lens 204 captures the previewed second image. The lens activation module 213a of the image integration software application 213 activates the first lens 203 or the second lens 204 on the image capture device 201 for capture of the first image and the previewed second image respectively. The support module 213b supports the first lens 203 and the second lens 204 for providing the first image and the second image from different directions. The support module 213b instructs the lens activation module 213a to activate any of the first lenses 203 and/or the second lenses 204 provided on the image capture device 201 based on the operator's preference to capture images from different directions without having to change the position of the image capture device 201. For example, if the operator wishes to take an image of himself/herself without having to reverse the imaging apparatus 200, the support module 213b instructs the lens activation module 213a to activate any of the first lenses 203 positioned in a rearward facing location on the image capture device 201 for capturing the operator's image. Similarly, if the operator wishes to integrate his/her image into a background image, the support module 213b instructs the lens activation module 213a to activate a first lens 203 facing the operator for capturing the operator's image and to activate any of the second lenses 204 positioned in the forward facing locations on the image capture device 201 that face the desired background for capturing the background image of choice for the integration.

The first flash unit 206 and the second flash unit 207 provide illumination during the capture of the first image and the capture of the previewed second image respectively. The operator captures the first image and the previewed second image using the capture control buttons 205. The capture control buttons 205 also provide the operator with flexible options while capturing the first image and the previewed second image.

The flash control unit 208 selectively controls the illumination level and timing of the first flash unit 206 and the second flash unit 207 during capture of the first image and capture of the previewed second image respectively. The light sensors 209 sense the amount of light incident on the first lens 203 and the second lens 204 during capture of the first image and the capture of the second previewed image. The flash control unit 208 controls intensity of illumination of the first flash unit 206 and the second flash unit 207 during capture of the first image and the previewed second image for matching lighting conditions of both the first image and the previewed second image. The light sensor 209 provides the flash control unit 208 with data regarding lighting conditions in front of the first lens 203 and the second lens 204, thereby allowing the flash control unit 208 to control intensity of illumination and control selective illumination of the first flash unit 206 and the second flash unit 207 during capture of the first image and the previewed second image.

The integration module 213c selectively integrates the captured first image and the captured second image at the selected location to create a composite image. The integration module 213c facilitates combination of image effects of the first image and the second image in the created composite image. The integration module 213c superimposes the captured first image and the captured second image at the selected location 401. The integration module 213c superimposes the captured first image over the captured second image or the captured second image over the captured first image. The captured first image includes the operator and the captured second image does not include the operator. The image integration software application 213 also fades edges of the captured first image to blend with the captured second image. The image integration software application 213 saves the second image and the superimposed first image as a single composite image.

Instructions for executing the image integration software application 213 are retrieved by a processor from a program memory of the image capture device 201 in the form of signals. Location of the instructions in the program memory is determined by a program counter (PC). The program counter stores a number that identifies the current position in the program of the image integration software application 213.

The instructions fetched by the processor from the program memory after being processed are decoded. After processing and decoding, the processor executes the instructions. For example, the integration module 213c defines instructions for selectively integrating the first image generated by the first lens 203 and the second image generated by the second lens 204 to facilitate combination of image effects of the generated first image and the generated second image in a composite image. The processor retrieves the instructions defined by the integration module 213c and executes the instructions.

The signature module 213d of the image integration software application 213 inserts a third image, for example, an image of the operator, into a captured image, for example, the captured first image, the captured previewed second image, or the composite image, as a signature. The signature module 213d instructs the lens activation module 213a to activate the first lens 203 for capture of an image of the operator for insertion into a captured second image, as a signature.

FIGS. 3-4 exemplarily illustrate rear views of the imaging apparatus 200. As illustrated in FIGS. 3-4, the first lens 203 is mounted at a rearward facing location on the camera body 215 of the image capture device 201, and the second lens 204 is mounted at a forward facing location on the camera body 215. The first lens 203 is adapted to capture, for example, the image of an operator and the second lens 204 is adapted to capture a frontal image. As illustrated in FIGS. 3-4, the imaging apparatus 200 further comprises multiple capture control buttons 205. The capture control buttons 205 provide the operator with different options and functions for capturing the first image and the second image. The capture control buttons 205, for example, provide functions for zoom control, exposure control, image capturing mode control, etc.

The image integration software application 213 utilizes the interface 214. The interface 214 is displayed on the display screen 212 or 301. The operator selects a location 401 in the previewed second image on the interface 214 for the integration. The operator may select the location 401 by moving an on-screen pointer or cursor (not shown) to the location 401 on the interface 214 displayed on the standard display 301 using one or more of the selection control buttons 211 of the image capture device 201 as exemplarily illustrated in FIG. 3, and more fully described subsequently herein. In another example, the operator selects the location 401 by touching a location 401 on the interface 214 displayed on the touch screen 212 using, for example, a stylus or a finger 403, as exemplarily illustrated in FIG. 4. In FIG. 4, multiple subjects 402 of the second image are displayed on the touch screen 212 and the operator selects a location 401 among the subjects 402 to integrate the operator's image.

Also illustrated in FIGS. 3-4 are a front flash unit 207, a rear flash unit 206, front and rear light sensors 209, the capture control buttons 205, and the selection control buttons 211. The selection control buttons 211 are, for example, a “Me-N-2” button 211a, an “R-Len” button 211f, a signature “S” button 211d, a size control button 211e, etc. The “R-Len” button 211f enables an operator to take an image of himself/herself and a friend without having to reverse the imaging apparatus 200. The “Me-N-2” button 211a enables the operator to integrate the captured first image into the captured second image. The “S” button 211d enables the operator to insert an image of the operator as a signature or the like in a captured image. The size control button 211e is, for example, a roller dial positioned on the side of the image capture device 201 to allow an operator to increase or decrease the size of the first image or the second image based on the operator's preference.

The operator activates an integration mode using one or more of the selection control buttons 211. The integration mode enables the operator to use the image capture device 201 for the integration. Prior to activation of the integration mode, the image capture device 201 is operated as a conventional image capture device. The operator previews the second image using the image capture device 201. The second image is, for example, an image of multiple subjects 402 excluding the operator. For example, the second image may be an image of friends of the operator at a park. The image capture device 201 comprises a display screen 212 or 301 for enabling the operator to preview the second image by viewing an area focused by the image capture device 201. The display screen 212 or 301 is, for example, a standard display 301 as exemplarily illustrated in FIG. 3 or a touch screen 212 as exemplarily illustrated in FIG. 4.

The image integration software application 213 also activates the first lens 203 at the rear of the image capture device 201 and the second lens 204 at the front of the image capture device 201 for enabling the capture of the first image, for example, the operator's image, and the capture of the previewed second image, respectively. The operator captures the previewed second image using the second lens 204 of the image capture device 201. The operator operates the image capture device 201 from the rear section of the image capture device 201. Hence, the captured second image does not include an image of the operator. The rear section of the image capture device 201 comprises multiple capture control buttons 205. The operator captures the previewed second image using the capture control buttons 205. The capture control buttons 205 also provide the operator with flexible options while capturing the first image and the previewed second image. The front flash unit 207 provides illumination during the capture of the previewed second image. The front flash unit 207 is positioned in a forward facing location on the image capture device 201 facing in the same direction as the second lens 204 of the image capture device 201 as exemplarily illustrated in FIG. 3.

The operator captures the first image using the first lens 203 of the image capture device 201. The first image is, for example, the operator's image. The rear flash unit 206 provides illumination during the capture of the first image. The rear flash unit 206 is positioned in a rearward facing location on the image capture device 201 facing in the same direction as the first lens 203 of the image capture device 201 as exemplarily illustrated in FIGS. 3-4. Alternatively, the rear flash unit 206 may be used for illumination during capture of both the first image and the second image. The second image, for example, is not captured before the capture of the first image. The first image of the operator is, for example, captured before the second image is captured, or the first image and the second image are captured simultaneously.

The image integration software application 213 superimposes the captured first image over the captured second image or the captured second image over the captured first image at the selected location 401. The captured first image includes the operator and the captured second image does not include the operator. Therefore, the first image is integrated into the second image using the image capture device 201. For enabling the image integration to be performed, the image integration software application 213 scales down the resolution of the first image to a fraction of the resolution of the second image. Hence, the smaller first image is overlaid on top of the second image to preferably prevent the first image from obscuring the second image.

The image integration software application 213 processes the captured first image, the captured second image, and the composite image based on preferences of the operator. The captured first image is integrated into the captured second image using, for example, a “Me-N-2” button 211a. The first lens 203, for example, takes a picture of only the operator without a background. The second lens 204 captures the background, for example, mountains, buildings, trees, people, etc. The image integration software application 213 then integrates the image of the operator into the image of the background to create a single composite image. Different methods are used to process the captured first and second images using, for example, the software application, eprompt®, a processor board, etc. The image capture device 201 comprises, for example, a face or anatomy recognition unit written in the software of the image integration software application 213 for capturing the image of the operator and placing the image of the operator next to the second image, behind the second image, or between the second images captured by the second lens 204 and saves the first image and the second image into a single composite image.

The image integration software application 213 evaluates the field and focal distances of the first image and the previewed second image from the first lens 203 and the second lens 204. The image integration software application 213 updates the preview of the second image shown to the operator indicating the appropriate image boundaries required for integrating the first image with the second image. The operator then presses one of the capture control buttons 205 to capture the first image and the previewed second image. When the operator takes the picture, both the first and the second images will be captured. The image integration software application 213 first processes the first image for identifying the operator's face using the face or anatomy recognition unit in the integration module 213c of the image integration software application 213. The image integration software application 213 identifies the boundaries of the operator's image and extracts the image data representing the operator from the first image. The image integration software application 213 applies an algorithm to differentiate the image of the operator from the background of the first image and performs a mirror reversal of the operator's image for integration into the second image.

The image integration software application 213 also processes the second image and identifies the foreground subjects from the background by applying an algorithm to identify the faces or torsos in the second image. The image integration software application 213 also interprets the focal distance of the subjects in the second image, and scales the operator's image to a size that represents the operator scaled to the focal distance of the second image's subjects based on an average arm's length distance of the operator from the image capture device 201, or using an actual computed focal distance for the image of the operator if available from the image capture device 201. The image integration software application 213 applies foreground elements from the first image as identified by an algorithm to the second image and presents a composite image to the operator. The composite image is composed of pixels from both the first image and the second image.

The following logic is applied for selection of each pixel from each of the first image and the second image for display in the composite image. Pixels from the second image identified as belonging to faces or torsos in the second image are, for example, rendered first. Pixels from the first image identified as belonging to the face or torso of the operator are rendered next. Pixels from the second image that are identified as not belonging to the faces or torsos of the subjects in the second image are then rendered. The image integration software application 213 supports controls that allow the image of the operator to be moved around the composite image in order to render a desired image. The image integration software application 213 recomputes the composite image and varies the location of pixels from the first image for integration into the second image. The image integration software application 213 computes other unspecified composite images that result from software or hardware based manipulation of the first image and the second image within the image capture device 201 to yield a composite image that incorporates pixels from both the first image and the second image.

In an embodiment, the image integration software application 213 fades edges of the captured first image to blend with the captured second image. The image integration software application 213 converts dimensions of the first image during superimposition for blending the first image of the operator with the second image. The image integration software application 213 converts the first image to dimensions proportional to the dimensions of the second image. The image integration software application 213 saves the second image with the superimposed first image as a single composite image on the imaging apparatus 200.

In another embodiment, the first lens 203 and the second lens 204 are also used independently to capture the first image of the operator and the second image respectively. If the first lens 203 and the second lens 204 are used independently, the image capture device 201 functions as a conventional camera. The first lens 203 is, for example, used to capture the first image of the operator without superimposing the first image of the operator on another image. When the first lens 203 is used to capture the first image of the operator without superimposition, the operator previews the first image on the display screen 212 or 301 to ensure correct focus. The operator activates the first lens 203 and the second lens 204 independently using one or more of the selection control buttons 211, for example, the rear lens “R-Len” button 211f as exemplarily illustrated in FIGS. 3-4. For example, the operator activates the first lens 203 using the “R-Len” button 211f to take an image of himself/herself and a friend without having to reverse the imaging apparatus 200. In this case, the operator can view himself/herself and the friend on the display screen 212 or 301 and use only the first lens 203 to capture the image of the operator and the friend.

In another embodiment, the operator has an option of inserting an image of the operator as a signature in a captured image using one of the selection control buttons 211, for example, the signature “S” button 211d as exemplarily illustrated in FIGS. 3-4. When the “S” button 211d is pressed, the image integration software application 213 inserts the operator's image into the captured image in a predefined location or in a location selected by the operator. The image integration software application 213 may automatically insert the operator's image in a predefined bottom right location or a predefined bottom left direction. Alternatively, the operator may select the location for inserting the operator's image on the captured image by pressing the “L” button 211b and “R” button 211c of the image capture device 201 as exemplarily illustrated in FIG. 3. Pressing the “L” button 211b moves the inserted operator's image in a general left direction and pressing the “R” button 211c moves the inserted operator's image in a general right direction. The size of the inserted operator's image is, for example, the size of a postage stamp.

The lens activation module 213a of the image integration software application 213 activates the first lens 203 or the second lens 204 for capture of the first image and the previewed second image respectively. For example, when the operator presses the “R-Len” button 211f on the image capture device 201, the lens activation module 213a activates the first lens 203. When the operator presses the “Me-N-2” button 211a, the lens activation module 213a activates both the first lens 203 and the second lens 204, and also activates the integration mode.

The signature module 213d of the image integration software application 213 instructs the lens activation module 213a to activate the first lens 203 for capture of an image of the operator for insertion into a captured second image, as a signature, when the operator presses the “S” button 211d on the image capture device 201. The signature module 213d inserts the captured operator's image into a predefined location or a location selected by the operator on the captured second image. The signature module 213d inserts the captured operator's image into a predefined bottom right position or a predefined bottom left position. Alternatively, pressing the “L” button 211b or “R” button 211c on the image capture device 201 moves the inserted operator's image in a general left or right direction respectively. Repeatedly pressing the “L” button 211b and the “R” button 211c allows the operator to precisely select the location of the operator's image on the captured image.

Consider an example of an operator John at a party with his friends at a crowded venue. John wants to take a picture of himself with his friends at the party. John does not want to ask a third party, for example, a stranger to take the picture. John also does not want to set a self timer and try and position and support a camera for the image capture or abandon the camera in the crowded venue. Using the imaging apparatus 200 disclosed herein, John does not need to ask a stranger to take the picture or abandon the imaging apparatus 200.

John activates the integration mode of the imaging apparatus 200 by pressing on the location selection unit 210 labeled “Me-N-2” as illustrated in FIGS. 3-4. John points the imaging apparatus 200 at his friends and previews a picture of his friends without himself in the picture. John selects a location 401 on the previewed picture of his friends on the interface 214 displayed on the display screen 212 or 301 of the image capture device 201 corresponding to where he would like his picture to be superimposed in the previewed picture. John captures the previewed picture using the image capture device 201. Simultaneously, John also captures a picture of himself using the image capture device 201. The first lens 203 of the image capture device 201 takes John's picture and the second lens 204 takes the picture of his friends without him. In this example, the first image is John's picture and the second image is the picture of John's friends without John.

The imaging apparatus 200 then superimposes John's picture over the picture of John's friends without John, at the selected location 401, to obtain a picture of John with his friends. The imaging apparatus 200 resizes John's picture to fit in the picture of John's friends appropriately. The imaging apparatus 200 saves the picture of John with his friends as a single composite picture. Hence, John has a picture of himself with his friends without using a self timer feature or asking other people to take the picture.

John can also use the imaging apparatus 200 to take a picture of himself and a friend without superimposition. John activates the first lens 203 of the image capture device 201 by using the “R-Len” button 211f on the image capture device 201. He then previews his image and his friend's image on the display screen 212 or 301 of the image capture device 201 without having to reverse the image capture device 201. He then presses one of the capture control buttons 205 of the image capture device 201 to capture the picture of himself and his friend.

Consider another example of using the imaging apparatus 200 as, for example, a digital camera, for integrating images. An operator, for example, John activates the integration mode by pressing the “Me-N-2” on the imaging apparatus 200. The imaging apparatus 200 captures a second image of a single subject 402 or a group of subjects 402 in front of the imaging apparatus 200 and a first image of the operator, John. The first image of John is integrated into the second image of the subjects 402, for example, a group of friends. John focuses on his group of friends and then prepares to capture the first image of him. The imaging apparatus 200 is equipped with a preview unit 202, for example, the liquid crystal display (LCD) with the touch screen 212. John first views his group of friends on the LCD screen. John then touches the LCD screen at the exact position where he wishes to place himself among his group of friends. The second lens 204 captures the second image of John's group of friends and the first lens 203 captures the first image of John behind the imaging apparatus 200. John then presses one of the capture control buttons 205, for example, a click button, on the imaging apparatus 200 to capture both the first image and the second image simultaneously. The light sensor 209 determines lighting conditions in front of the first lens 203 and the second lens 204 of the image capture device 201. The flash control unit 208 obtains data regarding the lighting conditions in front of the first lens 203 and the second lens 204 from the light sensor 209. The flash control unit 208 then controls the illumination of the first flash unit 206 and the second flash unit 207 for enabling the lighting conditions of the first image and the previewed second image to match when the first image and the previewed second image is captured. The first flash unit 206 and the second flash unit 207 of the imaging apparatus 200 hence provide necessary illumination at the time of capturing the images. The first flash unit 206 and the second flash unit 207 are, for example, activated simultaneously while capturing the second and first images respectively. The image integration software application 213 then proportionately places a first image of John at the location 401 selected by John within the second image.

Alternatively, the “L” button 211b and the “R” button 211c as exemplarily illustrated in FIG. 4, enables the operator, i.e. John, to select a location 401 within the second image either to the left, the right of the group in the second image. This arrangement is used in the imaging apparatus 200 without the LCD touch screen 212 facility. The “L” button 211b and the “R” button 211c indicating left and right directions respectively are used to select the location 401 for the placement of John's image within the second image of the group of John's friends. Pressing the “L” button 211b indicates that the first image of John is to be placed to the left of his group of friends and pressing the “R” button 211c indicates that the first image of John is to be placed to the right of his group of friends. This enables John to be in the image with his friends even though he is not physically present with his group of friends at the moment of capturing the image. The imaging apparatus 200 also saves John the hassle of finding a stranger to capture the image for him or abandoning the imaging apparatus 200 for using a self timer option. John thus protects his imaging apparatus 200 from theft by being in constant possession of the imaging apparatus 200.

John also has the option of inserting his image as a signature in a captured image using the “S” button 211d on the image capture device 201. Consider an example where John captures an image of a rose. John wishes to send the captured image of the rose to his mother. John wants his mother to know that he captured the image for her. John presses the “S” button 211d on his digital camera and the image integration software application 213 inserts a small image of John of the size of a postage stamp in a selected location 401 on the captured image of the rose. John uses the “L” button 211b and the “R” button 211c on the image capture device 201 to place the image of John in the bottom left or bottom right of the captured image of the rose respectively. Pressing the “L” button 211b or “R” button 211c on the image capture device 201 moves the inserted operator's image in a general left or right direction respectively, thereby allowing the operator to select the location 401 of the operator's image on the captured image. Alternatively, the image integration software application 213 automatically inserts John's image in the bottom left or bottom right corner of the image of the rose.

Consider another example of John on a trip with his family. John wishes to take a picture of his family and himself in front of the capitol building. However, John is reluctant to ask a stranger to click the picture as the stranger might not be a reliable person for handing over a digital camera. Additionally, John is apprehensive of not communicating effectively with the stranger. Alternatively, John has to place the digital camera at a suitable distance to focus on the family in front of the capitol building and activate a self timer for a certain period of time, for example, 10 seconds. John then has to return to the location where his family is before completion of 10 seconds to be present in the picture with his family. However, by using the imaging apparatus 200 disclosed herein, John need not ask the stranger, or activate the self timer to take the picture. John presses one of the capture control buttons 205 on the imaging apparatus 200 to capture both the first and second images simultaneously. The image integration software application 213 then proportionately places a first image of John at the location 401 selected by John within the second image of his family.

Another use of the “Me-N-2” button 211a is illustrated in the following example. Consider a situation where John wishes to capture an image of himself with another person, for example, his wife. With a conventional digital camera, John has to reverse the digital camera and extend his arm holding the digital camera as far as he can to capture the image while making sure both he and his wife are within the range of the second lens 204. However, with the imaging apparatus 200, John presses the “R-Len” button 211f to enable the use of the first lens 203. The LCD screen on the reverse of the camera is used to properly line oneself with the background for capturing the image. Also, John ensures that both he and his wife are included within the range of the first lens 203 by viewing the LCD screen and adjusting the camera position to capture the image. John then presses one of the capture control buttons 205, for example, a click button to capture the image. The first flash unit 206 provides necessary illumination for capturing their image. Thus, a clear image is captured without the possibility of the captured image being crooked or John and his wife being out of range.

Consider another example where John is at the Grand Canyon with a multiple lens cell phone comprising the image integration software application 213 disclosed herein. John calls his mother to show her the beauty of the canyon and presses the signature “S” button 211d on the cell phone in order to show his mother what he is looking at and to allow her to see him talking to her at the same time. When John presses the “S” button 211d on the cell phone, the signature module 213d of the image integration software application 213 instructs the lens activation module 213a to activate the first lens 203 for filming John while he is talking to his mother and to activate the second lens 204 for filming the Grand Canyon. When the “S” button 211d is pressed, the signature module 213d inserts John's recording into the recording of the Grand Canyon, as a signature on the display screen 212 or 301. The cell phone transmits the composite recording to John's mother via a communication network. John's mother will therefore be able to view the recording of the Grand Canyon along with John's recording as a signature in, for example, the bottom right hand corner of her display screen. The majority of the display screen will display the beauty of the Grand Canyon John is viewing while the bottom right hand corner will display John talking to his mother. As John films the Grand Canyon, he is connected by cell phone to his mother and her image is on the front bottom of his display screen 212 or 301 via his mother's phone/camera.

Consider another example where John is in a conference call with a client overseas. John may want to show his client documents or images and recordings of a building that he is constructing for the client. John may use the multiple lens cell phone to show the documents or images and recordings and at the same time ask questions. When John presses the “S” button 211d on the cell phone, the signature module 213d of the image integration software application 213 instructs the lens activation module 213a to activate the first lens 203 for recording John while he is talking to his client and to activate the second lens 204 for recording the image of the building. When the “S” button 211d is pressed, the signature module 213d inserts John's recording into the recording of the building, as a signature on the display screen 212 or 301. The cell phone transmits the composite recording to the client overseas via a communication network. John's client will therefore be able to view the building and see and hear John at the bottom right hand corner of the client's display screen. The use of this technology makes communication personal and allows clear communication due to visual affects.

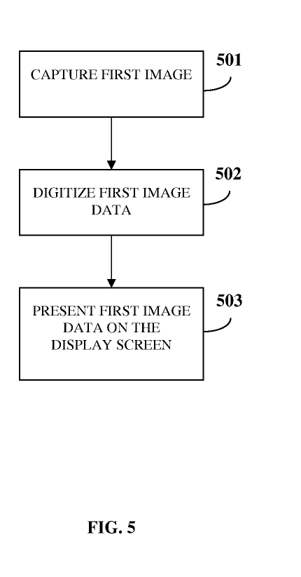

FIG. 5 exemplarily illustrates a flowchart comprising the steps of capturing an image of an operator using a rear lens 203, herein referred to as the “first lens”, on the image capture device 201. The operator activates the first lens 203 using the rear lens “R-Len” button 211f, illustrated in FIGS. 3-4, to take an image of himself/herself and a friend without having to reverse the imaging apparatus 200. When the operator presses the “R-Len” button 211f, the lens activation module 213a activates the first lens 203. In step 501, the first image, that is, the image of the operator, is captured. In step 502, the image integration software application 213 digitizes the first image data. In step 503, the image integration software application 213 presents the first image data on the display screen 212 or 301. The first lens 203 is therefore used to capture the image of the operator and the friend without reversing the imaging apparatus 200.

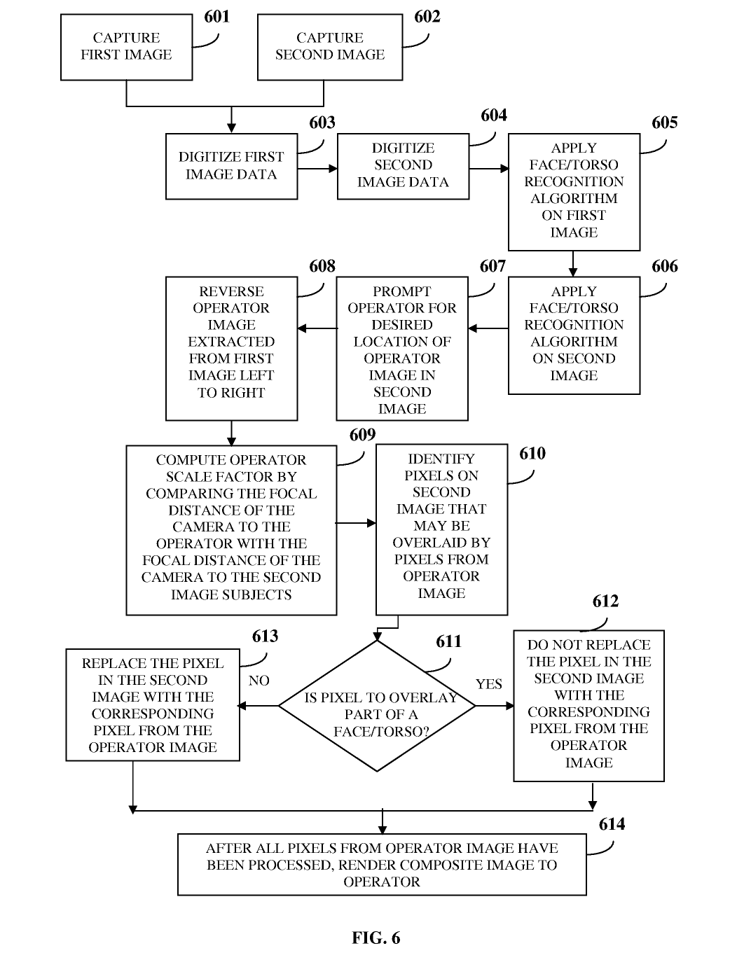

FIG. 6 exemplarily illustrates a flowchart comprising the steps of integrating a first image of an operator into a second image of photograph subjects. The image capture device 201 herein exemplarily referred to as a “camera”, comprising the first lens 203 and the second lens 204 is provided to an operator as exemplarily illustrated in FIGS. 3-4. In step 601, the operator uses the first lens 203 of the camera to capture the operator's image herein referred to as the “first image”. In step 602, the operator uses the second lens 204 of the camera to capture an image of a photograph subject herein referred to as the “second image”. In step 603, the image integration software application 213 provided on the camera digitizes the first image data into pixels. In step 604, the image integration software application 213 digitizes the second image data into pixels. In step 605, the image integration software application 213 applies, for example, a face/torso recognition algorithm on the first image. Similarly, in step 606, the image integration software application 213 applies the face/torso recognition algorithm on the second image. In step 607, the image integration software application 213 prompts the operator to select a desired location for inserting the operator's image in the second image.

In step 608, the operator's image in the first image is reversed from left to right. In step 609, the image integration software application 213 computes the operator scale factor by comparing the focal distance of the camera to the operator with the focal distance of the camera to the subjects in the second image. In step 610, the image integration software application 213 identifies pixels from the second image that may be overlaid by pixels from the operator's image. In step 611, the image integration software application 213 checks if the pixels from the operator's image overlay part of a face or torso of the subjects in the second image. In step 612, if the pixel from the operator's image overlays part of the face or torso of the subjects in the second image, the image integration software application 213 does not replace the pixel in the second image with the corresponding pixel from the operator's image. In step 613, if the pixel from the operator's image does not overlay part of the face or torso of the subjects in the second image, the image integration software application 213 replaces the pixel in the second image with the corresponding pixel from the operator's image. After all the pixels from the operator's image have been processed, in step 614, the image integration software application 213 renders a composite image comprising the operator's image within the second image to the operator.

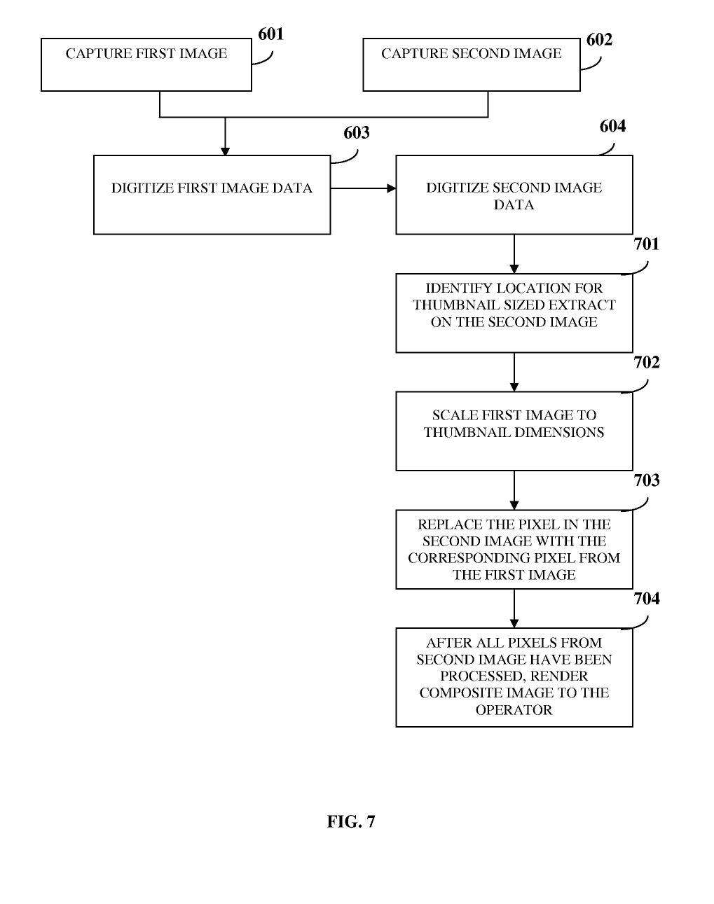

FIG. 7 exemplarily illustrates a flowchart comprising the steps of inserting a thumbnail sized first image into a second image, as a signature. As disclosed in the detailed description of FIG. 6, in step 601, the operator uses the first lens 203 of the camera to capture the operator's image herein referred to as the “first image”. In step 602, the operator uses the second lens 204 of the camera to capture an image of a photograph subject herein referred to as the “second image”. In step 603, the image integration software application 213 provided on the camera digitizes the first image data into pixels. In step 604, the image integration software application 213 digitizes the second image data into pixels. In step 701, the user identifies location for a thumbnail sized extract on the second image for inserting the thumbnail sized first image. In step 702, the image integration software application 213 scales the first image to thumbnail dimensions. In step 703, the image integration software application 213 replaces the pixel in the second image with the corresponding pixel from the first image. After all the pixels from the second image have been processed, in step 704, the image integration software application 213 renders the composite image comprising the thumbnail sized first image inserted into the second image, to the operator.

It will be readily apparent that the various methods and algorithms described herein may be implemented in a computer readable medium appropriately programmed for general purpose computers and computing devices. Typically a processor, for example, one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, central processing unit (CPU) devices, computing devices, microcontrollers, digital signal processors or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include dynamic random access memory (DRAM), which typically may constitute the main memory. Transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments disclosed herein.

The foregoing examples have been provided merely for the purpose of explanation and are in no way to be construed as limiting of the present invention disclosed herein. While the invention has been described with reference to various embodiments, it is understood that the words, which have been used herein, are intended to be only words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods applications and uses, such as are within the scope of the appended claims. Those skilled in the art, having the benefit of the teachings of this specification, may affect numerous modifications thereto and changes may be made without departing from the scope and spirit of the invention in its various aspects.

I claim:

1. A method of integrating a first image into a second image, comprising:
providing an image capture device comprising at least one first lens and at least one second lens to an operator;
providing an image integration software application on said image capture device, wherein said image integration software application utilizes an interface on said image capture device;
previewing said second image using said image capture device;
selecting a location in said previewed second image on said interface by said operator for said integration;
capturing said previewed second image by said operator using said at least one second lens of said image capture device;
capturing said first image using said at least one first lens of said image capture device; and
integrating said captured first image and said captured second image at said selected location by said image integration software application to create a composite image, wherein said created composite image is displayed on said interface on said image capture device.

2. The method of claim 1, wherein said integration comprises superimposing said captured first image over said captured second image, wherein said captured first image includes said operator and said captured second image does not include said operator.

3. The method of claim 1, wherein said integration comprises superimposing said captured second image over said captured first image, wherein said captured second image does not include said operator and said captured first image includes said operator.

4. The method of claim 1, wherein said location in said previewed second image is selected by said operator using one of a touch screen and a plurality of selection control buttons provided on said image capture device.

5. The method of claim 4, wherein said previewed second image is selected by said operator using said selection control buttons.

6. The method of claim 1, further comprising providing illumination during said capture of said first image and said capture of said previewed second image by a first flash unit and a second flash unit respectively.

7. The method of claim 6, further comprising providing a flash control unit on said image capture device for selectively controlling illumination level and timing of said first flash unit and said second flash unit during said capture of said first image and said capture of said previewed second image.

8. The method of claim 1, further comprising providing light sensors on said image capture device that sense amount of light incident on said at least one first lens and said at least one second lens during said capture of said first image and said capture of said previewed second image.

9. The method of claim 1, wherein said at least one first lens is positioned in a rearward facing location on said image capture device and said at least one second lens is positioned in a forward facing location on said image capture device.

10. The method of claim 1, wherein said image integration software application processes said captured first image, said captured second image, and said composite image based on preferences of said operator, wherein said operator sets said preferences using one or more of a plurality of selection control buttons.

11. The method of claim 1, wherein said image integration software application activates said at least one first lens and said at least one second lens for enabling said capture of said first image and said capture of said previewed second image respectively.

12. The method of claim 1, wherein said image integration software application inserts a third image into one of said captured first image, said captured previewed second image, and said composite image, as a signature.

13. An imaging apparatus for integrating a first image into a second image, said imaging apparatus comprising:
an image capture device, said image capture device comprising:
a preview unit for previewing said second image;
a location selection unit that enables an operator to select a location in said previewed second image for said integration;
at least one second lens that captures said previewed second image, said at least one second lens being positioned in a forward facing location on said image capture device; and
at least one first lens that captures said first image, said at least one first lens being positioned in a rearward facing location on said image capture device;
an image integration software application for said image capture device;
an interface under control of said image integration software application for accepting said location selected by said operator; and
said image integration software application comprising an integration module that selectively integrates said captured first image and said captured second image at said selected location to create a composite image.

14. The imaging apparatus of claim 13, wherein said integration module superimposes said captured first image over said captured second image, wherein said captured first image includes said operator and said captured second image does not include said operator.

15. The imaging apparatus of claim 13, wherein said integration module superimposes said captured second image over said captured first image, wherein said captured second image does not include said operator and said captured first image includes said operator.

16. The imaging apparatus of claim 13, wherein said location selection unit comprises one of a touch screen and a plurality of selection control buttons that enables said operator to select said location in said previewed second image and set preferences on said image capture device.

17. The imaging apparatus of claim 13, wherein said image capture device further comprises a first flash unit and a second flash unit that provide illumination during said capture of said first image and said capture of said previewed second image respectively.

18. The imaging apparatus of claim 17, wherein said image capture device further comprises a flash control unit that selectively controls illumination level and timing of said first flash unit and said second flash unit during said capture of said first image and said capture of said previewed second image respectively.

19. The imaging apparatus of claim 13, wherein said image capture device further comprises light sensors that sense amount of light incident on said at least one first lens and said at least one second lens during said capture of said first image and said capture of said previewed second image.

20. The imaging apparatus of claim 13, wherein said image capture device further comprises a plurality of capture control buttons that provides said operator with flexible options for capturing said first image and said previewed second image.

21. The imaging apparatus of claim 13, wherein said image integration software application further comprises a lens activation module that activates said at least one first lens and said at least one second lens on said image capture device.

22. The imaging apparatus of claim 13, wherein said image integration software application comprises a signature module that inserts a third image into one of said captured first image, said captured previewed second image, and said composite image, as a signature.

23. A computer program product comprising computer executable instructions embodied in a computer readable storage medium, wherein said computer program product comprises in combination:
a first computer parsable program code that provides an image integration software application on an image capture device;
a second computer parsable program code that provides an interface on said image capture device for accepting a location selected by an operator on a previewed second image;
a third computer parsable program code that processes said previewed second image captured by a second lens of said image capture device;
a fourth computer parsable program code that processes a first image captured by a first lens of said image capture device; and
a fifth computer parsable program code that integrates said processed first image and said processed second image at said selected location.

24. The computer program product of claim 23, further comprising a sixth computer parsable program code that superimposes one of said captured first image over said captured second image and vice versa.

25. The computer program product of claim 23, further comprising a seventh computer parsable program code that activates a first flash unit and a second flash unit for providing illumination during said capture of said first image and said capture of said previewed second image respectively.

26. The computer program product of claim 25, further comprising an eighth computer parsable program code that selectively controls illumination level and timing of said first flash unit and said second flash unit during said capture of said first image and said capture of said previewed second image.

27. An imaging apparatus comprising:
a first optical unit for generating a first image;
a second optical unit for generating a second image;
a support module that supports said first optical unit and said second optical unit for providing said generated first image and said generated second image from different directions; and
an integration module that selectively integrates said generated first image and said generated second image to facilitate combination of image effects of said generated first image and said generated second image in a composite image.

28. The imaging apparatus of claim 27, further comprising a camera body comprising:
said first optical unit being mounted at a rearward facing location on said camera body and adapted to capture image of an operator;
said second optical unit being mounted at a forward facing location on said camera body and adapted to capture a frontal image;
a preview unit for previewing said frontal image and said operator image; and
said integration module that selectively integrates said operator image and said frontal image to create a composite image under control of said operator.
